(19) United States
(12) Patent Application Publication
(10) Pub. No.: US 2013/0227402 A1
(43) Pub. Date: Aug. 29, 2013

(54) SYSTEM, APPARATUS, METHOD, AND APPLICATIONS FOR MEASURING AND REPORTING ON THE PROCESS OF COMPOSING WRITTEN MATERIAL

(71) Applicant: University of Rochester, (US)

(72) Inventors: Deborah F. Rossen-Knill, Rochester, NY (US); Ted Pawlicki, Rochester, NY (US)

(73) Assignee: UNIVERSITY OF ROCHESTER, ROCHESTER, NY (US)

(21) Appl. No.: 13/777,008

(22) Filed: Feb. 26, 2013

Related U.S. Application Data
(60) Provisional application No. 61/603,991, filed on Feb. 28, 2012.

(51) Int. Cl. G06F 17/24

(52) U.S. Cl. CPC G06F 17/24
USPC 715/255

(57) ABSTRACT

Tools in the form of hardware apparatus, software components, a system comprising hardware apparatus and software components, methods, and applications of said system and methods, which pertain to and enable the analysis of and reporting about the process of composing written material; i.e., the process of writing. An important and distinguishing attribute of at least certain aspects of the embodied invention is its utilization of software that unobtrusively measures and reports on how people write; i.e., again, the process of writing.

### RELATED APPLICATION DATA

This application claims the benefit of priority from U.S. Provisional application Ser. No. 61/603,991 filed on Feb. 28, 2012, the subject matter of which is incorporated by reference herein in its entirety.

### BACKGROUND

Embodiments of the invention most generally relate to the analysis of and reporting about the process of ‘composing written material,’ hereinafter, the ‘process of writing’). The phrase ‘analysis of writing’ is herein used to mean the determination or measurement of many characteristics associated with the process of writing, as will be further explained in greater detail below. Embodiments of the invention relate more specifically to the capture of relevant data, and the analysis of and reporting about the process of composing English texts based upon the captured data; however, alternative embodiments and aspects of the invention may also relate to the capture of relevant data, and the analysis of and reporting about the process of writing in non-English languages (e.g., German, Spanish, etc.,), computer programming languages (e.g., JavaScript, Self, Scheme), scientific languages (e.g., mathematics), and other written language formats known in the art based upon the captured data. Embodiments of the invention further pertain to tools and methods, implemented by software and/or hardware that enable the analysis of and reporting about the process of writing. Embodiments of the invention further pertain to apparatus, methods, and applications associated with the analysis of and reporting about writing techniques and skills, for example, including but not limited to, teaching writing skills and/or improving writing habits. Herein, writing ‘teachers’ and writing ‘students’ will sometimes be collectively referred to as “users,” and a person whose writing habits are being analyzed will be referred to as a ‘subject.’ More particularly, an embodiment of the present invention relates to the use of software-driven machines to collect (capture), analyze, and present (i.e., offer reports) information. While the users and subjects who use the present invention will likely be primarily human users and human subjects, the present invention may expand beyond human users and include embodiments where the users are purely artificial intelligence entities.

It is conventional for people and/or software to perform or attempt to perform certain types of analysis of writing or the process of writing. The reported analytic attempts use relatively primitive tools in their analyses of writing. For example, in Sommers, Nancy, “Revision Strategies of Student Writers and Experienced Adult Writers,” College Composition and Communication 31 (1980): 378-88, experienced writers gave quotes about how they personally define “revision”; however, the answers are abstract. The writers may have written their definitions using the tools such as pen and paper or, maybe they used a small tape recorder or, perhaps they submitted their answers using a set of primarily software-implemented tools such as ‘email.’ Analysis was based on interviews and comparison of small numbers of drafts. These tools are primitive in that they are relatively old technologies, as even email has been around for decades. These old tools are considered to be well suited to perform the traditional soft, subjective, ad hoc, and abstract analysis of scholarly writing (e.g., comparing novice writing to expert writing) as has traditionally been practiced.

Another category, non-scholarly analysis of writing, tends to have different objectives, which sometimes utilizes specialized software-based tools to accomplish its analysis. Two common examples of non-scholarly analysis of writing includes the typing test and the case where collaborative authors pass around a “marked-up” copy of a paper document. An example of a subject engaging in such a typing test is shown at http://youtu.be/rxjTgfGTLDo. In the typing test, a subject is given text to transcribe through a keyboard, and the subject's typing speed and/or accuracy is measured: (i) by ancient tools such as clocks and pen-and-paper grading; or (ii) by a software tool as is shown in the linked video. Typing tests are commonly used to help writers improve upon mechanical aspects of writing and to help employers objectively evaluate typing speed. Because the text is provided to the subject, it is the less ratiocinative, more mechanistic characteristics of the “writing” that are being analyzed in the typing test scenario.

In the passing around a “marked-up” copy of a paper document scenario, a draft contract document, for example, may be circulated among various negotiators. The first negotiator writes down that “payment will be $10”; then the second negotiator draws a red line through the “10” and writes “20” in red ink. The first negotiator will generally analyze this mark-up when she gets the contract draft back from the second negotiator, possibly feeling that the second negotiator thinks that she is being offered a bad deal and wants more money, and that this was what motivated the mark-up. The upwards revision from “10” to “20” could have been made by the second negotiator by having a clean, new copy of the document drafted with the replacement made and with no mark-up. However, tools, such as red pens, have often been used to make mark-ups precisely because such mark-ups greatly help in certain types of analysis of writing. In this simple example, the first negotiator can reliably see and understand the adjustment from 10 to 20, and can be expected to reliably cogitate on its ramifications vis-a-vis the thought processes of the second negotiator. Of course, the second negotiator knows this and chose a red pen tool (as contrasted with, e.g., a more sedate black pen) for the precise purpose of helping the first negotiator reliably analyze her writing and know at least certain of her underlying thoughts in an efficient and reliable way.

It is noted that the characteristics of writing identified by use of the red pen in this example are the changes between one draft of the document and a successive draft, and such characteristic is concrete, determinative, and discrete. However, the analysis in this example is ad hoc and subjective; i.e., the first negotiator applies her common sense to know what the second negotiator is really driving at with her revision. The response of the first negotiator is likely to be subjective and ad hoc as well. For example, the first negotiator might tell the second negotiator that she cannot pay $20, but can sweeten the deal in some other non-monetary way; or the first negotiator may tell the second negotiator to ‘go jump in a lake.’

The traditional red ink pen process for tracking and making document changes has been implemented as a user-selectable, automatic feature on modern word processing programs. Software-based “track changes” tools (hereinafter “Conventional Track Changes Tools” or, more simply, “Conventional Track Changes” or revision histories) are very popular, and Conventional Track Changes Tools are the subject of many software patents and implemented in many various commercial software products. However, Conventional Track Changes Tools are not generally well suited to the scholarly analysis of writing and have not gained widespread use as a tool for performing the scholarly analysis of writing. Conventional Track Changes do not continuously track all changes made to the text, but affect affects only saved text. Moreover, Track Changes does not capture newly produced text that has not yet been saved. In addition, it does not capture writing-related behaviors, such as taking breaks.

The embodied invention recognizes that improved software-based tools would benefit various approaches of analysis of writing.

“Characteristics of writing,” as used herein, refers to any physical fact and/or mental fact related to writing. Some of the characteristics of writing that have been explored in the prior art include: (i) the writer's user input of text speed (see, the typing test prior art); (ii) the writer's state of mind when writing a bit of text (see, e.g., Penrose, Ann M., and Cheryl Geisler. “Reading and Writing without Authority,” College Composition and Communication 45.4 (1994): 505-20, or the contract example above); (iii) spelling accuracy (see, typing test; also, spell checker software); (iv) time distribution of composition of new text tasks versus review and/or revision of previously-written text tasks (see, e.g., Sommers, Nancy, “Revision Strategies of Student Writers and Experienced Adult Writers,” College Composition and Communication 31 (1980): 378-88, although it is noted that this “time distribution,” such as it is, is only presented in rather rough and subjective terms—it is still considered as a “characteristic of writing” as that phrase is used herein).

Many other characteristics of writing are possible to imagine, and a few additional examples include: (i) the elevation (above sea level) at which a piece of writing is performed; (ii) the number of times an author scratches her head while writing; (iii) the average number of letters per word in a piece of writing; (iv) the rhyme scheme and/or pattern of emphasized syllables in a piece of writing; (v) the emotional tone of the writing (for example, happy, frustrated, etc.); (vi) the reading level (for example, middle school level) of the written text); (vii) the cost of the equipment upon which the writing is physically performed; (viii) the speed of text entry normalized by average word length; (ix) the subject matter of an author's dreams the night before she drafted a piece of writing; and/or the time of day when writing occurs. What is being expressed here is the breadth of the bare concept of “characteristics of writing.” For example, this document should not be taken to necessarily suggest that analyzing dreams would be a useful way of performing analysis of writing, just that it is one possible parameter, related to the process of writing (by happenstance, if not in a cause-and-effect sense) that can be measured and studied.

The concept of “characteristics of writing” becomes even broader when one considers other types of writing besides the drafting of prose and poetry passages of mere alphanumeric characters. This is an important type of writing, but not the only type of writing. Other examples of “characteristics of writing” include: (i) the number of times a visual artist changes colors when drawing an image using a tablet input device and stylus; (ii) a CAD/CAM designers relative use of a line tool versus her use of a connector tool; (iii) wrist pain symptoms versus the speed of coding by a computer “coder” writing machine readable code for computers; and/or (iv) the aesthetic qualities of a calligrapher's handwritten output after it is scanned into a computer. In the calligrapher example, it is noted that the writing itself is not done on a computer, but the analysis of writing may still be performed by a computer.

The inventors have recognized the benefits and advantages to be realized by a tool(s) (systems, apparatus, methods) that non-intrusively captures, analyzes, and reports on writing behaviors of the writing process, such a tool enabling the potential to revolutionize writing instruction because it makes what has been invisible to the writer, the educator, and the researcher both visible and understandable. Further benefits and advantages may be particularly realized by utilizing such a tool(s) applied to the categories of instructional writing and the research of writing. Further, such a tool(s) will allow educators and researchers to better understand patterns and variations in writing process across individual and groups of writers, across different kinds of texts, and across different writing contexts. Moreover, such a tool's database may serve as a rich resource for research—big data, data mining. It would be further beneficial and advantageous to enable such a tool(s) on various platforms such as Windows, Mac, ‘cloud,’ and others to be developed. These and other benefits and advantages may be realized by the embodied invention as described herein below with reference to the various figures and in the appended claims

To the extent that specific references or publications are discussed above, these discussions should not be taken as an admission that the discussed publications or references are prior art for patent law purposes. To the extent that specific publications or references are discussed hereinabove, they are all hereby incorporated by reference into this document in their respective entireties.

Embodiments of the present invention may be expressed in various ways, such as through programmed computer systems/apparatus, in non-transiently stored software present on a software storage mechanism (see DEFINITIONS section), in methods, in algorithms, and so on, collectively referred to herein as a tool or tools for the analysis of and reporting about the process of writing.

In various non-limiting aspects of the invention, the embodied tool(s) may implicate one or more of the following general tasks: (i) collection of writing-related data by a computer system; (ii) retention of types of data not previously retained (e.g., collection of novel types of writing-related data by a computer system); (iii) computation of writing characteristics; (iv) communication of writing characteristics; (v) presentation of writing characteristic related information (e.g., computer-based presentations); and/or (vi) evaluation of writing processes. In some or all of these areas, specially programmed computer systems may be employed, as a practical matter, to carry out the various tasks or techniques of certain aspects of the invention.

An embodiment of the invention is a tool that is utilized to non-intrusively capture, analyze, and report on writing behaviors of the writing process. As used herein, the aforementioned tool(s) may comprise an apparatus; a system comprising one or more apparatus and or components (which may include software components) such as, e.g., one or more of: a word processor, a word processing program, data storage medium, data capture software, a keystroke monitor, a student report generator, an instructor report generator a student database, a class database, a system database, a writing analysis engine; a method; and combinations thereof. According to various non-limiting aspects, the embodied tool(s) that is utilized to non-intrusively capture, analyze, and report on writing behaviors of the writing process may capture, analyze, and/or report on one or more of the following parameters: amount of text written, type and frequency of text revision, content and change of content, size of content change, timing such as beginning and/or end times, writing breaks.

Non-limiting aspects of the invention are directed to software (such as software stored on a software storage device (see DEFINITIONS section)) utilized to collect, retain, computationally process, communicate and/or present data related to the analysis of the writing process. For example, changes to the text may be collected and retained on a substantially continuous basis so that this text-change characteristic of the writing process can be computationally processed, communicated, presented and/or further analyzed (for example, subjectively analyzed by a writing instructor). This process and implementing software are different than Conventional Track Changes because Conventional Track Changes only retains track change information on a snapshot basis, not continuously. Thus in certain aspects, a scholarly analysis of the writing process, as opposed to the fundamentally different non-scholarly analysis of writing that is conventionally facilitated by Conventional Track Changes, is enabled.

In some aspects of the present invention, the embodied tool(s) will promote and/or reinforce improved writing habits and/or practices by collecting information related to a given subject's writing process, and by being able to compare and share data on writing behavior of novice and expert writers. This information may relate to various aspects of writing, such as: (i) comprehensive and continuous tracking of text changes over the entire writing process for a given document; (ii) time related information (how long it takes to complete various certain writing tasks); (iii) calendar related information (for example, the time of day that a change is made); and/or (iv) changes in extra textual aspects of writing, such as computerized spell checking.

Software tools according to the embodied invention may be programmed for a standalone computer, or a set of computers in data communication. For example, a teacher and a student may communicate via the software on different and discrete physical computers (for example, smart phones).

### BRIEF DESCRIPTION OF THE DRAWINGS

The present invention will be more fully understood and appreciated by reading the following Detailed Description in conjunction with the accompanying drawings, in which:

FIG. 1 shows a screen shot of a document about to be composed, being composed, or composed by a user on a display screen of the system. There is a graphical user interface (GUI) menu along the top as presented by an exemplary version of Microsoft Word® word-processing application. Respective GUI icons are shown in the upper left corner of the menu bar for turning the embodied tool for the analysis of and reporting about the process of writing ON and OFF, and for generating a Report, according to an illustrative embodiment of the invention;

FIG. 2 shows a screen shot of the Home Page of the embodied system generated by activating the Report icon referred to in FIG. 1. The illustrated screen shot shows interactive Home Page features icons including “About” at the bottom-center of the screen and “Home,” “Writing Process,” “Charts,” and “Writing Resources” across the top of the screen. Parameters measured by the operating system such as “Word Count,” “Break Count,” “Number of Changes:,” and “Average Change Size:” and interactive links to their respective reports are displayed in the center of the screen, according to an illustrative embodiment of the invention;

FIGS. 3(a-d) show screen shots of charted reports for the parameters referred to in FIG. 2 generated by clicking on their respective interactive links. FIG. 3a: Word Count Chart Report; FIG. 3b: Chart Measuring Breaks Report; FIG. 3c: Number of Changes Chart Report; FIG. 3d: Average Change Size Chart Report, according to illustrative embodiments of the invention; and

FIG. 4 shows a schematic block diagram of system software tool components and their interactive associations with an exemplary student and teacher, according to an exemplary embodiment of the invention.

### DETAILED DESCRIPTION OF EXEMPLARY, NON-LIMITING EMBODIMENTS OF THE INVENTION

Embodiments of the invention are directed to tools in the form of hardware apparatus, software components, a system comprising hardware apparatus and software components, methods, and applications of said system and methods, which pertain to and enable the analysis of and reporting about the process of composing written material; i.e., the process of writing. An important and distinguishing attribute of at least certain aspects of the embodied invention is its utilization of software that unobtrusively measures and reports on how people write; i.e., again, the process of writing.

The inventors have recognized that what those skilled in the art may refer to as ‘bad’ writing comes from a bad writing process used by the writer. Instructors or those endeavoring to teach people how to write better have been challenged in their attempts due in large part to the difficulty with, or inaccessibility to, the ability to see the writing process used by the writer. Moreover, the inventors believe that until the instant invention, no means were commercially available that could capture and analyze relevant writing process data, and report about the writing process based on that data. Accordingly, the embodied invention provides a solution to improve the writing process by revealing how people write. The critical areas for improving the process of writing addressed by the embodied invention include, but are not limited to, making effective changes to a prior document by changing chunks (phrases, sentences, paragraphs, as opposed to word replacement) of text, shaping the text for readability through reorganizing, revising for concision/precision, and proofing for spelling and usage; maximizing productivity; and matching writing processes to learning styles.

To accomplish these objectives, exemplary parameters captured, analyzed, and reported on by the embodied invention include amount of text written, types of text revisions and frequency of revisions, content changes, average size of content changes, beginning and end writing times, and time breaks during writing. A key aspect of the successful enablement of the embodied invention is the ‘unobtrusive’ manner in which these (and possibly other) parameters related to the process of writing are captured and analyzed.

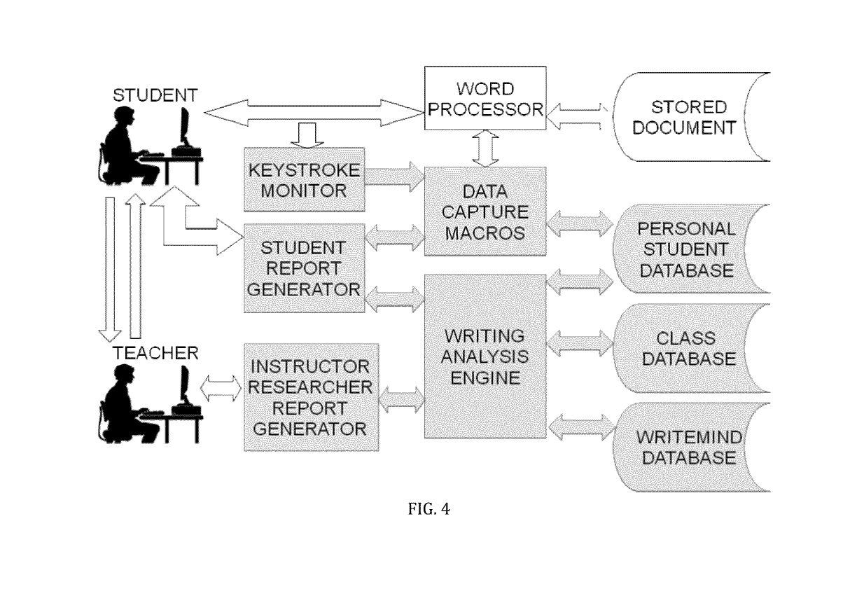

FIG. 4 shows a schematic block diagram of embodied system software tool components, basically comprising a word processor, a keystroke monitor, data capture macros, data bases, and report generators, and their interactive associations with an exemplary student and teacher.

More particularly, the word processor component is a software application used to create, edit, and layout documents. Well known examples of word processor applications include Microsoft Word and OpenOfficeWriter. The word processor component may be an existing off-the-shelf application running independently, may be custom written as part of the embodied system as one skilled in the art would know how to do, or may be included as a component of a cloud based system. Word processing applications can run directly on a host computer or be a component of a web/cloud based application service.

The keystroke monitor is a software program that runs behind the scenes, invisible to the user. Examples of such “keyloggers” are available both commercial available and freely available as open source software. This software tool component can either be configured to interact with the user's host computer's operating system or be directly integrated into the word processor. Its function is to detect a keystroke, or a mouse or tablet gesture. Sequences of these operations are recorded by this program and bundled with timestamps for later processing by data capture macros.

Data capture macros are sets of software routines. They are software programs that can run stand alone, or from within the word processor as a software extension, or as a sub component of the keystroke monitor. The function of this tool component is to aggregate the raw data from the keystroke monitor and construct features and measures appropriate for the analysis of the user/writer's high level cognitive writing process. The algorithms, abstractions, and data structures that realize the embodiment of this module constitute a set of features and metrics based on the existing body of scientific research regarding writing processes.

The data bases include a Personal Student Database, a Class Data Base, and a system Data base, and comprise software constructs implemented using standard relational or data base systems technology (e.g., Microsoft Access, MySQL, Postgress, etc.). The data base schemas that constitute the type and structure of the information stored are based on the existing body of scientific research regarding writing processes and are tuned to the specific user audience associated with each data base.

The Personal Student Database stores detailed information for each individual user along with the user/writer's personal reflective analysis of their process. This is the most detailed data set as it is designed for use by individuals.

The Class Data Base stores information regarding several/many users who are all taking a class/course of study in writing. This data base is intended for use by an instructor. It maintains information regarding individuals.

The system Data Base stores information regarding many writers at many levels of development. It is intended for use by writing education researchers and aggregates information across many groups of users. It does not contain personal information regarding individuals; rather, it contains information regarding behaviors and practices of groups of writers at different levels. This data base would be available to individual students and instructors for the use of comparison between novice and expert writing techniques.

Report generators are software applications containing graphical user interfaces that provide both users and instructors with views of the data regarding both student and expert performance. An individual user has need for a different set of information than an instructor or researcher.

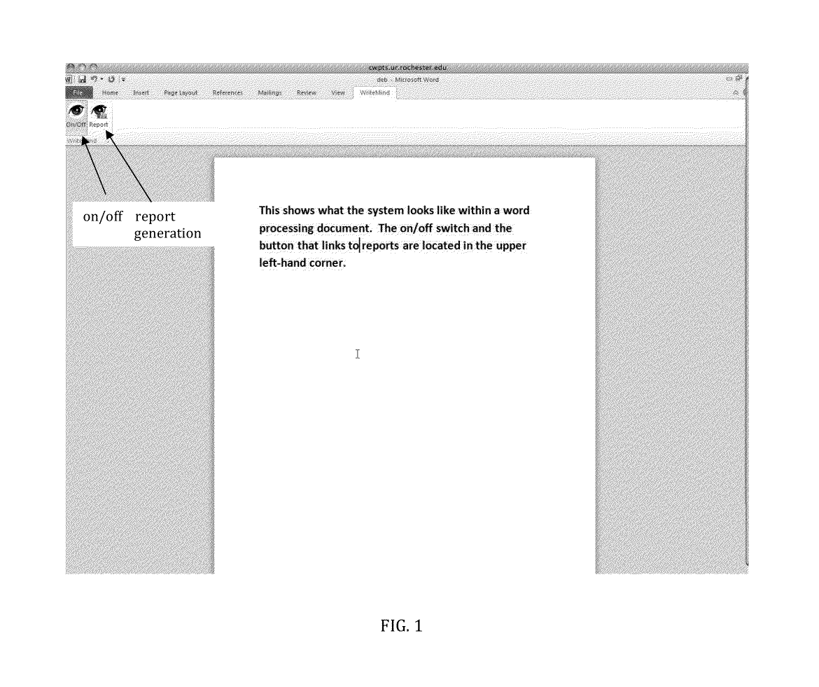

FIGS. 1 to 3 show various screenshots generated by the embodied invention software. (It is noted that while certain figures may include system names such as “EyeWrite” and “WriteMind,” these names have no significance to the invention per se).

FIG. 1 shows a screen shot of a document about to be composed, being composed, or composed by a user on a display screen of the system. There is a graphical user interface (GUI) menu along the top as presented by an exemplary version of Microsoft Word® word-processing application. Respective GUI icons are shown in the upper left corner of the menu bar for turning the embodied tool for the analysis of and reporting about the process of writing ON and OFF, and for generating a Report. As the user writes, the system works unnoticed by user to capture, analyze, and form reports on the user's writing behaviors.

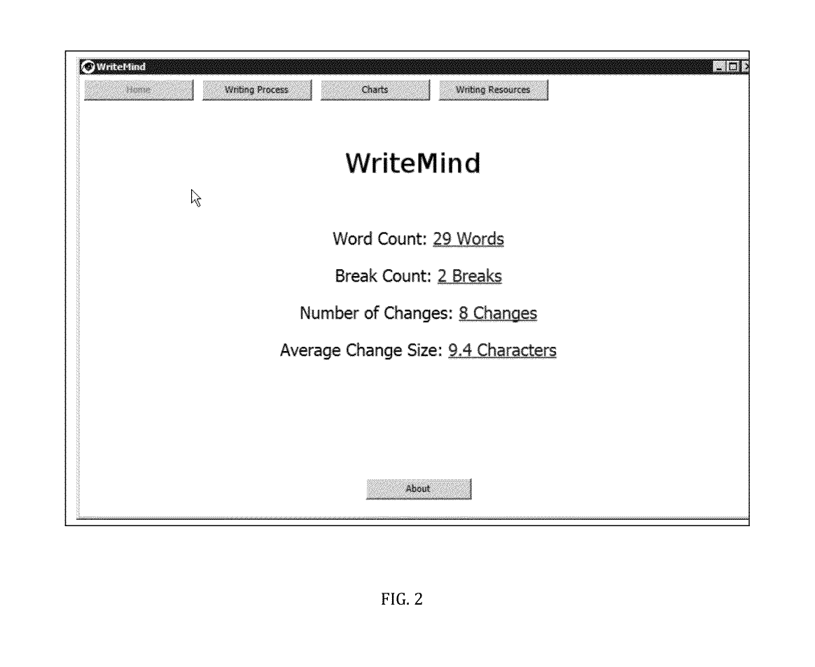

FIG. 2 shows a screen shot of the Home Page of the embodied system generated by activating the Report icon referred to in FIG. 1. The illustrated screen shot shows interactive Home Page features icons including “About” at the bottom-center of the screen and “Home,” “Writing Process,” “Charts,” and “Writing Resources” across the top of the screen. Parameters measured by the operating system such as “Word Count,” “Break Count,” “Number of Changes:,” and “Average Change Size:” and interactive links to their respective reports are displayed in the center of the screen. Activating the Report icon in the word-processing document (see FIG. 1) takes the user to the system's homepage. The Home-page feature “About” is a link to system specs. Clicking on any of the displayed general measures of writing behaviors (e.g., ‘29 Words,’ ‘2 Breaks,’ ‘8 Changes,’ ‘9.4 Characters’) leads the user to detailed information for that measurement. The “Writing Process” icon provides interactive pages that prompt writers to reflect on writing behaviors. The “Charts” icon enables a direct link to all of the system's reports on the user's writing behavior. The “Writing Resources” icon is a link to interactive pages where instructors and students locate relevant writing resources.

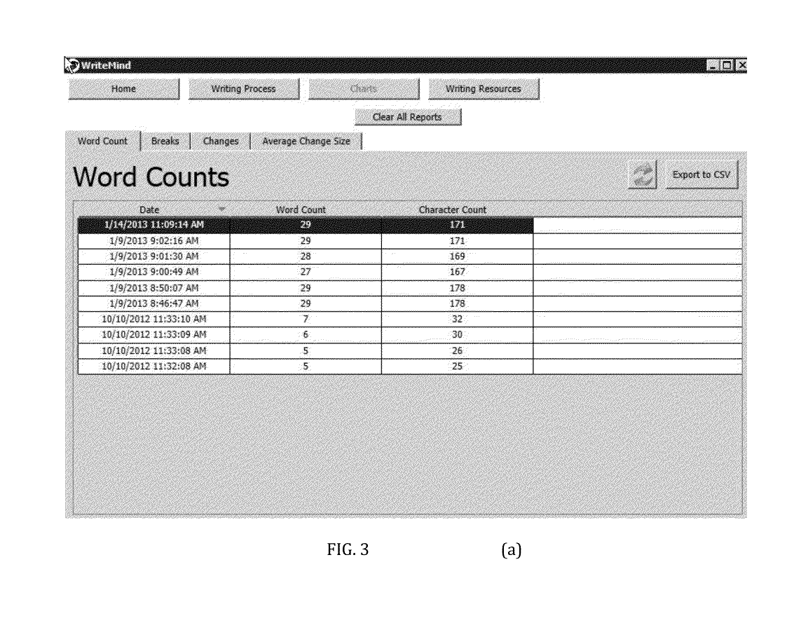

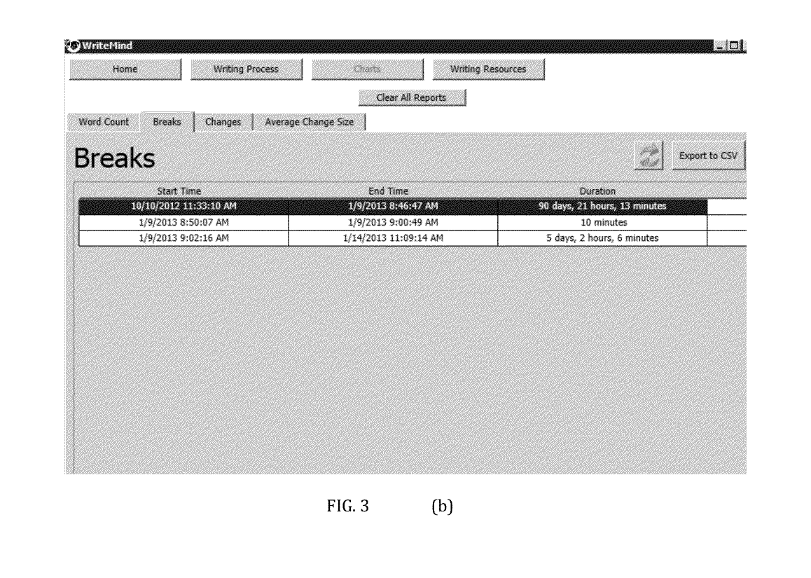

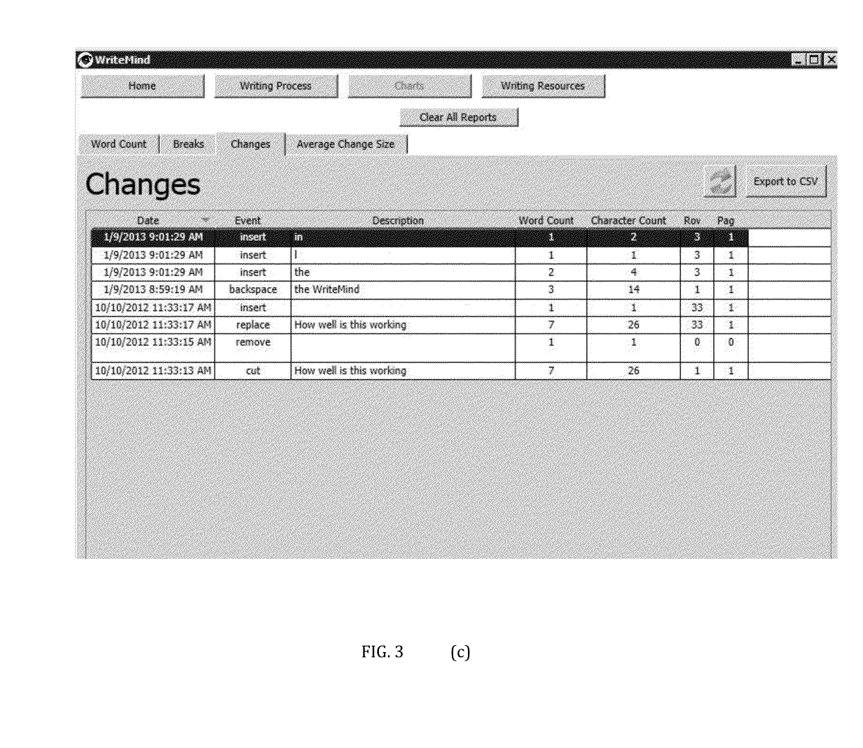

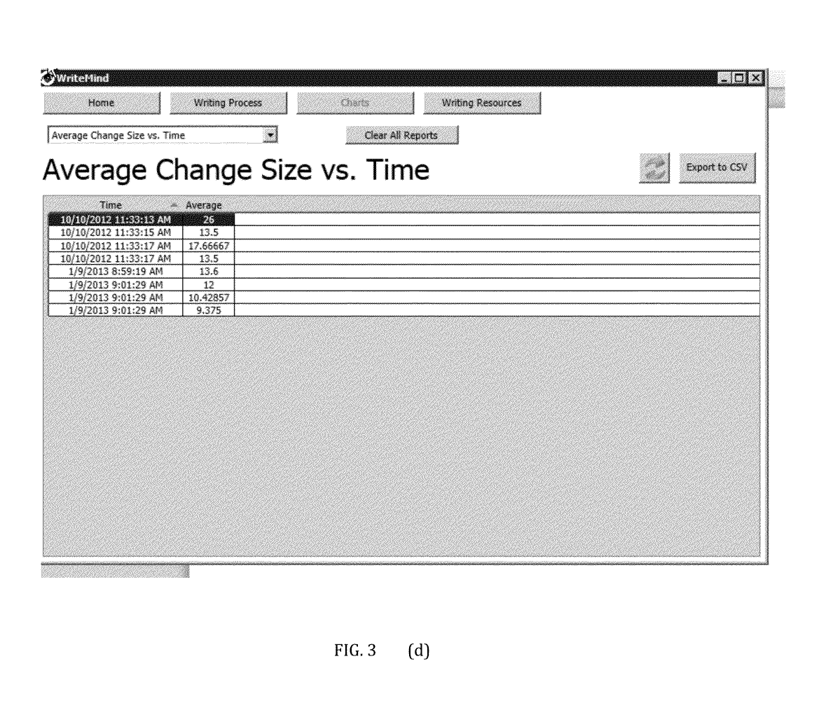

FIGS. 3(a-d) show screen shots of charted reports for the parameters referred to in FIG. 2 generated by clicking on their respective interactive links. The reports are sortable by column heading; all reports have links to other reports, and have built-in export capability. FIG. 3a: Word Count Chart: reports on word- and character-count over time and total word- and character-count. This data may be sorted by date, word count, and character count; FIG. 3b: Chart Measuring Breaks: reports on frequency of breaks, when they begin, and when they end. A break corresponds to periods when the system is ON and there has been no word-processing activity for some specified minimum number of minutes, in the illustrated case, 10 minutes; FIG. 3c: Number of Changes Chart: shows number of changes over time, type of change (e.g., insert or delete), the text affected by the change (e.g., “I” was inserted), length of change in words and characters, and the location of the change (row and page); FIG. 3d: Average Change Size vs. Time chart: adds information about average size of text changed (word and character count) over time. The “Clear All Reports” tab clears data from all reports associated with the immediate document. “Home” returns the user to the overview screen (FIG. 1). Closing the window takes the user back to the word-processing document. Report information is saved with each document.

The embodied invention is useful to writing students, educators, and educational researchers, helping writers at all levels in tutoring and teaching contexts. As an integrated component of a writing course, it may generate concrete discussions about the choices novice and experienced writers make as they draft and redraft documents to formulate and communicate their meanings. Its use may also lead to better answers to many critical questions about writing, which include: (i) What are the similarities and differences between how novice and expert writers revise at the sentence level?; (ii) As students develop, how does their writing/revision process change?; (iii) How does degree of familiarity with topic or field affect the writing/revision process?; (iv) How does context (in school, in professional settings, in social settings, etc.) affect the writing/revision process?; (v) As students encounter new genres, how does their writing/revision process change?; (vi)How do second language learners (at different levels) write and revise their essays; and/or (vii) How do students with different kinds of learning disabilities write and revise their essays?

The embodied system is currently implemented as a plug-in module to the Microsoft Word word-processing system and is written in the Visual Basic computer programming language.

According to an aspect, the embodied invention address the novice writer's disconnect between sentence-level revisions and global revision in writing. The distinction made visible to the student and teacher is that between sentence-level revisions that affect local meaning and sentence-level changes that affect global meaning. Very generally, there are two kinds of changes at the sentence level. The first, typically associated with the novice writer, includes spelling corrections, deleting single words for concision, swapping out single words, and fixing for correct usage. These kinds of changes are at the level of proof-reading and do not significantly affect global meaning. This first kind of change takes place within the sentence; it does not typically lead to restructuring sentence boundaries. The second kind of change involves deleting, pasting and repositioning meaningful chunks of text, typically phrases and clauses and also words. These kinds of changes cross sentence boundaries and redefine sentence boundaries, and do affect the global meaning at the sentence, paragraph and essay levels.

The embodied invention makes the writer's revision process visible by generating reports that catalogue chunks of text according to operations. One could, for example, see a list of all text that was deleted, or all text that was pasted. This in turn would allow a student or teacher to consider first, whether or not students were typically manipulating meaningful chunks (e.g., phrases, clauses) or relatively un-meaningful chunks (e.g., letters, words). This feedback might then be used as the basis for discussions with students about how they revise, how they might revise, what changes (if any) they observe in their revision process over a semester, and the results of these changes in developing an essay. Ideally, these discussions would draw on classroom instruction in rhetorical grammar—a new paradigm in writing instruction that helps students see meaningful sentence-level choices, and how these choices shape message and affect the reader's ability to understand the message. The embodied invention will make it possible for students to connect abstract discussions about revision to the concrete actualities of their revision process.

Exemplary features of the embodied software will now be discussed. The output will consist of a log file containing time stamped editing events. An additional program will run to analyze the log files to generate statistical analysis of the user's actions. Featured and/or planned features include the following: (i) Track delete, paste/insert, copy actions implemented through menu and short-cut keys; (ii) Track actions for newly generated and established text; (iii) Generate a list of all text affected by a revision action; and/or (iv) Organize lists of text in units that are meaningful to the student: text would be organized by type of chunk. Initially, this would involve organizing text by size (less than a word, a word, two words, three words, four words, five words, and so on). This will allow for a quick assessment of the kinds of units being manipulated (letters to correct spelling/typos/word form, words, phrases, clauses, sentences, paragraphs). Links may also be provided to parsers or corpus analysis programs, as these would allow for an organization scheme based on the function of a textual unit in a sentence (e.g., noun phrase, verb phrase, metadiscoursal unit); (v) Include time stamps on all actions; (vi) Relate changes to text position in document (through time stamps); (vii) Organize related moves (if one word replaces another, these would be grouped together); (viii) Track keystrokes (or words) per specified time period; (ix) Track revision actions per specified time period; (x) Create an analyzer to generate reports for each type of change and for actions as they relate to time; (xi) Create a user-friendly interface that allows the student to turn program on and off; (xii) Tracks breaks taken by writer; (xiii) Maintains a database per document for analysis; (xiv) Works on multiple documents on the same computer; (xv) Reports on writing behavior through text description and graphics (with or without graphs/charts); (xvi) Links to pages where students maintain logs of their writing behavior and goals; and/or (xvii) Links to pages that offer students advice on writing.

Log files may be written to the writer's local machine. The software contains a desktop icon making the user aware of when it is loaded and whether it is turned on or off. Some embodiments of the present invention write to a cloud-based web-service for centralized storage and analysis.

### Terms and Definitions

Any and all published documents mentioned herein shall be considered to be incorporated by reference, in their respective entireties. The following definitions are provided for claim construction purposes:

Module/Sub-Module: any set of hardware, firmware and/or software that operatively works to do some kind of function, without regard to whether the module is: (i) in a single local proximity; (ii) distributed over a wide area; (ii) in a single proximity within a larger piece of software code; (iii) located within a single piece of software code; (iv) located in a single storage device, memory or medium; (v) mechanically connected; (vi) electrically connected; and/or (vii) connected in data communication.

Software storage device: any device (or set of devices) capable of storing computer code in a non-transient manner in one or more tangible storage medium(s); “software storage device” does not include any device that stores computer code only as a signal.
1.1. Blank Document
   A blank document shall be a document which is devoid of author generated content.
1.2. Clipboard
   The clipboard refers to a storage space where content may be placed and later retrieved.
   The precise order in which stored content is retrieved is unspecified.
1.3. Empty Document
   An empty document shall be taken to be the range consisting of the beginning and end of the document.
2. Locations and Range
2.1. Locations
   A location shall be defined as the ordered triple of page, p, row, r, and column, c: (p, r, c).
2.1.1. Column
   A column shall be taken to be a subunit of a row containing exactly one character or other unit of content.
2.1.2. Row
   A row shall be taken to be a single line of text containing n columns, c₁, c₂, . . . , cₙ. n is bounded by the size of the page and any formatting which may be present, and by the visual width of the content in the contained columns.
2.1.3. Page
   A page shall be taken to be a bounded region of content occupying the space of an arbitrarily sized piece of paper. A page shall consist of n rows, r₁, r₂, . . . , rₙ; n is bounded by the size of the page and any formatting which may be present. A page shall be more broadly divided into a header, a footer, and a body.
2.1.4. Special Locations
2.1.4.1. End of the Document
   The end of the document shall be taken to be the location consisting of the highest numbered column, the highest numbered row, and the highest numbered page. Locations describing content in the following cases are not considered the end of the document:
      Headers
      Footers
      Footnotes except where they shall appear collected following the end of the primary body of the work.
      Page numbers
      Any other content not belonging to the primary body of the work but which may appear after the body of the work.
2.1.4.2. Beginning of the document
   The start of the document shall be taken to be the location consisting of the lowest numbered column, the lowest numbered row, and the lowest numbered page. Locations describing content in the following cases are not considered the start of the document:
      Headers
      Footers
      Page numbers
      Any other content not belonging to the primary body of the work but which may appear before the body of the work.
2.1.4.3. Insertion point
   The insertion point shall be taken to be the location in the work where content will be next added or removed.
2.2. Range
   A range of the document shall be defined by two locations, l₁ and l₂, such that l₂ is, identically, the location of an insertion point following the final content unit in the range. That is, range R₁ may be written as a half open interval [l₁, l₂).
2.2.1. An empty range is then taken to be one in which l₁ is equal to l₂.
3. Content
3.1. Printed Content
   Printed content shall be taken to be any content which is visible to the author a reader without special aids or considerations.
3.2. Unprinted Content
   Unprinted content shall include any content which the author or reader must take special consideration or action to view or content for which there is no printed symbol.
3.3. Textual Content
   Textual content shall be taken to be any code point as present in the Unicode standard, ISO/IEC 10646:2012 with the following specifications.
      Code points 0000-0020, and 007F-009F are considered unprinted content.
      Code points 0009-000D, and 0020 are additionally considered to be whitespace content.
      All remaining code points are considered printed content
3.4. Non-Textual Content
   Non-textual content shall be any content which is not textual content. This may include, but is not limited to, images, audios, and videos.
3.5. Author Generated Content
   Author generated content shall be any content which is produced, directly or indirectly, by the author. Author generated content shall exclude any prefabricated content present at the initial creation of the document. This includes, but is not limited to:
      Form fields
      Templates
4. Additions
   An addition shall be defined, generally, as any author generated content, C₀, printed or unprinted which is aggregated with the current content so as to extend the work. All such events shall be recorded as “Addition” with the following specializations.
4.1. Appends
   An append shall be defined as any content, C₀, printed or unprinted, which is added at the end of the document. Such events shall be recorded as “Append”.
4.2. Inserts
   An insert shall be defined as any additions which occur prior to, but not at, the end of the document. Such events shall be recorded as “Insert”.
4.3. Pastes
   A paste shall be defined as an addition which is taken from the clipboard. Such events shall be recorded as “Paste”
   Additions shall be aggregated until an action of a separate category is made or the location of the insertion point is changed by an action other than the addition itself. This behavior shall be broken only where failing doing so would disrupt the continuity of the content recorded. Exceptions include the following:
      A paste shall always be recorded as a paste and shall terminate the current additions.
5. Removals
   A removal shall be generally defined as the elimination of content, C₀, printed or unprinted from the current content so as to shorten the work. Such events shall be recorded as “Remove” with the following specializations.
5.1. Cut
   A cut shall be defined as the removal of content, C₀, and its immediate placement onto the clipboard. Such events shall be recorded as “Cut”
   Removals shall be aggregated until an action of a separate category is made or the location of the insertion point is changed by an action other than the removal itself. This behavior shall be broken only where failing doing so would disrupt the continuity of the content recorded. Exceptions include the following:
      A cut shall always be recorded as a cut and shall terminate the current removal.
6. Special
   The following are events which do not fit into the previous sections.
6.1. Replace
   A replacement shall be defined as a removal followed immediately by an addition such that the events are, from the author's perspective, simultaneous. Such events shall be recorded as two events: a “Remove” followed by an “Additions”. The “Addition” event may alternatively be any one of the specializations of additions without restriction.
6.2. Copy
   A copy shall be defined as the placing of content C₀, printed or unprinted, on the clipboard without removing C₀. Such events shall be recorded as “Copy”. A copy shall have no impact on the current event and shall not alter the content of the document.
6.3. Undo
   An undo shall be defined as the reversal of a previous action. Such events shall be recorded as “Undo”
6.4. Redo
   A redo shall be defined as the reversal of an undo. Such events shall be recorded as “Redo”

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

We claim:

1. A method for improving a characteristic of writing of a written document by a writer thereof, comprising:
composing a document including text using a machine-enabled word-processing software application, which text is visible on a display component as the document is being composed;
automatically making at least one of a time-stamped keystroke measurement, a time-stamped mouse gesture measurement, and a time-stamped tablet gesture measurement of a sequence of a plurality of parameters selected from the list of: an amount of document text written, a type of document text revision, a frequency of document text revision, a change in document content, an average size of the change in document content, a beginning document composition time, an ending document composition time, and a time break in document composition, wherein the measuring step is performed in a manner that is not visible on the display component as the document is being composed;
storing a selective collection of data indicative of a writing process associated with the writing of the written document;
analyzing said time-stamped measurements; and
reporting, upon request, about the measured plurality of parameters.

2. The method of claim 1, wherein the automatic measurement of the plurality of parameters includes all of the listed parameters.

3. The method of claim 1, wherein the reporting step further comprises reporting in a manner that is visible on the display component.

4. The method of claim 1, wherein the reporting step further comprises generating a plurality of different reports, which respectively pertain to a learning methodology for a process of writing and a teaching methodology for a process of writing.

5. The method of claim 1, wherein the step of storing a selective collection of data further comprises:
providing a plurality of databases including at least one each of:
a (student) database that stores detailed information for an individual user,
a (class) database that stores information regarding a plurality of concurrent users, and
a (system) database that stores information about a plurality of users having different writing skill levels, and
populating the (student) database with detailed information for each individual user along with the user's personal reflective analysis of their process,
populating the (class) database with information regarding a plurality of concurrent users, and
populating the (system) database with information about behaviors and practices of groups of users having different writing skill levels.

6. The method of claim 1, wherein the measured plurality of parameters is stored as a set of comprehensive text change metadata.

7. The method of claim 1, further comprising providing a plurality of data capture software routines programmed to aggregate raw data from the at least one of the time-stamped keystroke measurement, the time-stamped mouse gesture measurement, and the time-stamped tablet gesture measurement and construct features and measures appropriate for the analysis of the user's high level cognitive writing process, wherein the features and measures are based on the existing body of scientific research regarding writing process.

8. The method of claim 7, wherein the software runs in a stand-alone mode.

9. The method of claim 7, wherein the software runs from within the word processor as a software extension.

10. The method of claim 7, wherein the software runs from within the word processor as a sub-component of a keystroke monitoring component.

11. The method of claim 1, wherein the method runs on a local machine.

12. The method of claim 1, wherein the method runs on a server.

13. The method of claim 1, wherein the method runs on a cloud-based system.

14. The method of claim 1, wherein the characteristic of writing is the quality of the written document.

15. The method of claim 1, wherein the characteristic of writing is the ability of the writer to write the written document.

16. Software stored on a software storage medium, the software including:
a writing module programmed to receive data corresponding to a piece of writing by a subject through a user interface of a computer system;
a collection module programmed to collect all text changes on a comprehensive basis to form a set of comprehensive text change metadata; and
a retention module programmed to retain the comprehensive text change metadata even after step (a) is completed.

17. The software of claim 16, wherein the storage medium is a device.

18. The software of claim 16, wherein the storage medium is a computer network.

19. Software stored on a software storage medium, the software including:
a writing module programmed to receive data corresponding to a piece of writing by a subject through a user interface of a computer system;
a collection module programmed to collect at least some text changes, on at least a snapshot basis, to form a set of text change metadata;
a communication module structured and/or programmed to communicate at least some of the text change metadata to a n evaluator (human and/or software based); and
a presentation module structured and/or programmed to present at least some of the text change metadata to the evaluator.

20. The software of claim 19, wherein the storage medium is a device.

21. The software of claim 19, wherein the storage medium is a computer network.

22. A computer-based system, comprising:
a software-enabled word processing application used to create, edit, and layout a written document;
a software-enabled keylogger adapted to detect a keystroke, or a mouse gesture, or a tablet gesture, and record a plurality of time-stamped sequences of these operations;
a plurality of data capture software routines adapted to aggregate data from the keylogger;
a plurality of databases including at least one each of a database that stores detailed information for an individual user, a database that stores information regarding a plurality of concurrent users, and a database that stores information about a plurality of users having different writing skill levels; and
a plurality of software-enabled report generator applications each including a graphical user interface that provides selective views of data regarding writing performance.
